(19) United States
(12) Patent Application Publication
(10) Pub. No.: US 2025/0184636 A1
(43) Pub. Date: Jun. 5, 2025

(54) APPARATUS, SYSTEM, AND MOVING BODY

(71) Applicant: CANON KABUSHIKI KAISHA, Tokyo (JP)

(72) Inventors: TAKAFUMI MIKI, Kanagawa (JP); YUSUKE ONUKI, Kanagawa (JP); SHUHEI HAYASHI, Kanagawa (JP)

(21) Appl. No.: 18/952,193

(22) Filed: Nov. 19, 2024

(30) Foreign Application Priority Data
Nov. 30, 2023 (JP) 2023-202723

(51) Int. Cl. H04N 25/766; H04N 25/77

(52) U.S. Cl. CPC H04N 25/766; H04N 25/77

(57) ABSTRACT

An apparatus includes a plurality of pixels, a plurality of signal lines, and first connection wiring. Each of the plurality of pixels includes a photoelectric conversion unit and a selection unit. The plurality of signal lines includes a first group including a first signal line connected to a first pixel, a second group including a second signal line connected to a second pixel, and a second group including a third signal line connected to a third pixel. First shield wiring to which a fixed potential is supplied is located between the first group and the second group including the third signal line. The first connection wiring overlaps the first group and not the second group including the second signal line in a plan view.

### BACKGROUND

### Technical Field

The aspect of the embodiments relates to an apparatus, a system, and a moving body.

### Description of the Related Art

Complementary metal-oxide-semiconductor (CMOS) image sensors suitable for high-speed reading have been widely used in imaging apparatuses such as digital still cameras and digital video cameras in recent years. For example, Japanese Patent Application Laid-Open No. 2023-95414 discusses a CMOS image sensor that can reduce restrictions in simultaneously performing a plurality of different signal scans in parallel. Japanese Patent Application Laid-Open No. 2023-95414 discusses pixels equipped with three or more signal lines and two or more selection circuits, where a first selection circuit is used in a first operation mode and a second selection circuit different from the first selection circuit is used in a second operation mode. Japanese Patent Application Laid-Open No. 2018-137603 discusses a CMOS image sensor where parasitic capacitances are stabilized by laying out connection wiring, which is connected to output transistors and one of signal lines, to be orthogonal to all signal lines. Japanese Patent Application Laid-Open No. 2018-137603 discusses laying out the connection wiring, which is connected to output transistors and one of vertical signal lines, to be orthogonal to all the signal lines.

According to Japanese Patent Application Laid-Open No. 2023-95414 and Japanese Patent Application Laid-Open No. 2018-137603, crosstalk can occur through parasitic capacitances between signal lines used in the first operation mode and ones used in the second operation mode when a plurality of different signal scans is simultaneously performed in parallel.

### SUMMARY

According to an aspect of the embodiments, an apparatus includes a plurality of pixels arranged in a plurality of rows and a plurality of columns, and a plurality of signal lines, wherein each of the plurality of pixels includes a photoelectric conversion unit and a selection unit configured to control output of a pixel signal based on a charge generated by the photoelectric conversion unit to the signal lines, wherein the plurality of pixels includes a first pixel located at a first column and a first row, a second pixel located at the first column and a second row, and a third pixel located at a second column and the second row, the second column adjoining the first column, wherein the plurality of signal lines includes a first group including one or more of the signal lines and including a first signal line connected to the first pixel, a second group including one or more of the signal lines and including a second signal line connected to the second pixel, and a third group including one or more of the signal lines and including a third signal line connected to the third pixel, wherein the apparatus further comprises first connection wiring connected to the selection unit of the first pixel and the first signal line, wherein first shield wiring to which a fixed potential is supplied is located between the first group and the second group including the third signal line, and wherein the first connection wiring overlaps the first group and not the second group including the second signal line in a plan view in a direction orthogonal to a surface where the plurality of pixels is arranged.

Further features of the disclosure will become apparent from the following description of exemplary embodiments with reference to the attached drawings.

### BRIEF DESCRIPTION OF THE DRAWINGS

FIG. 1 is a block diagram of a photoelectric conversion apparatus according to a first exemplary embodiment.

FIG. 2 is an equivalent circuit diagram of pixels according to the first exemplary embodiment.

FIG. 3 is a timing chart illustrating vertical scans according to the first exemplary embodiment.

FIG. 4A is a plan view of the pixels according to the first exemplary embodiment.

FIG. 4B is a plan view of the pixels according to the first exemplary embodiment.

FIG. 5A is a sectional view of a pixel according to the first exemplary embodiment.

FIG. 5B is a sectional view of a pixel according to the first exemplary embodiment.

FIG. 5C is a sectional view of a pixel according to the first exemplary embodiment.

FIG. 6 is an equivalent circuit diagram of pixels according to a second exemplary embodiment.

FIG. 7A is a plan view of the pixels according to the second exemplary embodiment.

FIG. 7B is a plan view of the pixels according to the second exemplary embodiment.

FIG. 8A is a plan view of pixels according to a third exemplary embodiment.

FIG. 8B is a plan view of the pixels according to the third exemplary embodiment.

FIG. 9A is a sectional view of a pixel according to the third exemplary embodiment.

FIG. 9B is a sectional view of a pixel according to the third exemplary embodiment.

FIG. 10 is a functional block diagram of a photoelectric conversion system according to a fourth exemplary embodiment.

FIG. 11A is a functional block diagram of a photoelectric conversion system according to a fifth exemplary embodiment.

FIG. 11B is a functional block diagram of the photoelectric conversion system according to the fifth exemplary embodiment.

FIG. 12 is a functional block diagram of a photoelectric conversion system according to a sixth exemplary embodiment.

FIG. 13 is a functional block diagram of a photoelectric conversion system according to a seventh exemplary embodiment.

FIG. 14 is a functional block diagram of a photoelectric conversion system according to an eighth exemplary embodiment.

FIG. 15A is a functional block diagram of a photoelectric conversion system according to a ninth exemplary embodiment.

FIG. 15B is a functional block diagram of a photoelectric conversion system according to the ninth exemplary embodiment.

FIG. 16 is a sectional view illustrating an internal configuration of a document reading apparatus according to a tenth exemplary embodiment.

FIG. 17 is a block diagram illustrating a configuration of a control unit of the document reading apparatus according to the tenth exemplary embodiment.

FIG. 18 is a control flowchart for a central processing unit (CPU) according to the tenth exemplary embodiment.

### DESCRIPTION OF THE EMBODIMENTS

Exemplary embodiments will be described below with reference to the drawings. The following exemplary embodiments are intended to embody the technical concepts of the disclosure and not limit the disclosure. The sizes and positional relationship of members illustrated in the drawings may be exaggerated for the sake of clear description.

In the following description, similar components may be denoted by the same reference numerals, and a description thereof may be omitted. As employed herein, components having similar configurations may be denoted by reference numerals followed by “-” and numerals, like −1, −2, and −3, and a description thereof may be omitted.

The exemplary embodiments of the disclosure will be described in detail below with reference to the drawings. In the following description, terms indicating specific directions or positions (for example, “top”, “bottom”, “right”, and “left”, and other terms including these) are used as appropriate. These terms are used to facilitate the understanding of the exemplary embodiments with reference to the drawings, and the technical scope of the disclosure is not limited by the meanings of the terms.

As employed herein, a plane refers to a surface seen in a direction perpendicular to a light incident surface of a semiconductor layer. A cross section refers to a surface in a direction perpendicular to the light incident surface of the semiconductor layer. If the light incident surface of the semiconductor layer is a microscopically rough surface, planes and cross sections are defined with reference to the light incident surface of the semiconductor layer seen macroscopically.

A plan view refers to a view of the foregoing plane. For example, a plan view refers to a view of a surface where a plurality of pixels is arranged, seen in an orthogonal direction.

Each of the following exemplary embodiments mainly describes an imaging apparatus as an example of a photoelectric conversion apparatus. However, the exemplary embodiments are not limited to imaging apparatuses but also applicable to other examples of photoelectric conversion apparatuses. Examples include distance measurement apparatuses (apparatuses for distance measurement using focus detection or time of flight [ToF]) and light metering apparatuses (apparatuses for measuring the amount of incident light).

The conductivity types of the transistors described in the following exemplary embodiments are merely examples, and not limited to only those described in the exemplary embodiments. The conductivity types described in the exemplary embodiments can be changed as appropriate, and the gate, source, and drain potentials of the transistors are accordingly changed as appropriate. For example, if the conductivity type of a transistor functioning as a switch is changed, the low and high levels of the potential supplied to the gate can be reversed relative to the description in the exemplary embodiment.

The conductivity types of the semiconductor regions described in the following exemplary embodiments are also merely examples, and not limited to only those described in the exemplary embodiments. The conductivity types described in the exemplary embodiments can be changed as appropriate, and the potentials of the semiconductor regions are accordingly changed as appropriate.

In the following exemplary embodiments, circuit elements can be described to be connected to each other. In such cases, the elements of interest will be treated as being connected to each other even if there is another element interposed between the elements of interest, unless otherwise specified. For example, suppose that an element A is connected to one node of a multi-node capacitive element C, and an element B is connected to the other node. In such a case, the elements A and B are treated as being connected unless otherwise specified.

The following description schematically describes vertical scans as signal scans by the photoelectric conversion apparatuses, and schematically describes a case where signal lines are vertical signal lines extending in the vertical direction. However, an effect of reducing crosstalk can also be obtained in a case where the signal scans are horizontal scans and the signal lines are horizontal signal lines extending in the horizontal direction.

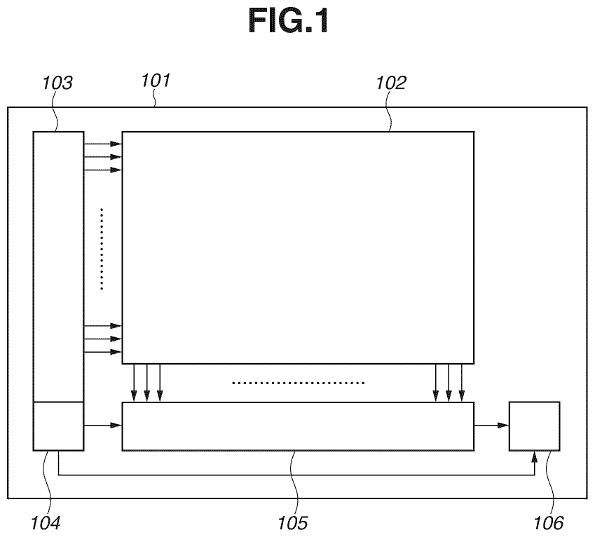

FIG. 1 is a schematic block diagram illustrating a photoelectric conversion apparatus according to a first exemplary embodiment. A photoelectric conversion apparatus 101 includes a photoelectric conversion region 102 where a plurality of pixels is arranged in a matrix, a vertical scanning circuit 103 for driving various units included in the pixels, a power supply unit 104, a horizontal scanning circuit 105 for reading electrical signals of the pixels, and an output unit 106 from which the electrical signals of the pixels are output. The plurality of pixels is arranged in a plurality of rows and a plurality of columns. The photoelectric conversion apparatus 101 can output the amount of light on the photoelectric conversion region 102 as two-dimensional electrical signals.

The photoelectric conversion apparatus 101 may include a first semiconductor layer and a second semiconductor layer stacked on each other. The photoelectric conversion region 102 is disposed on the first semiconductor layer. The vertical scanning circuit 103, the power supply unit 104, the horizontal scanning circuit 105, and the output unit 106 are disposed on the second semiconductor layer.

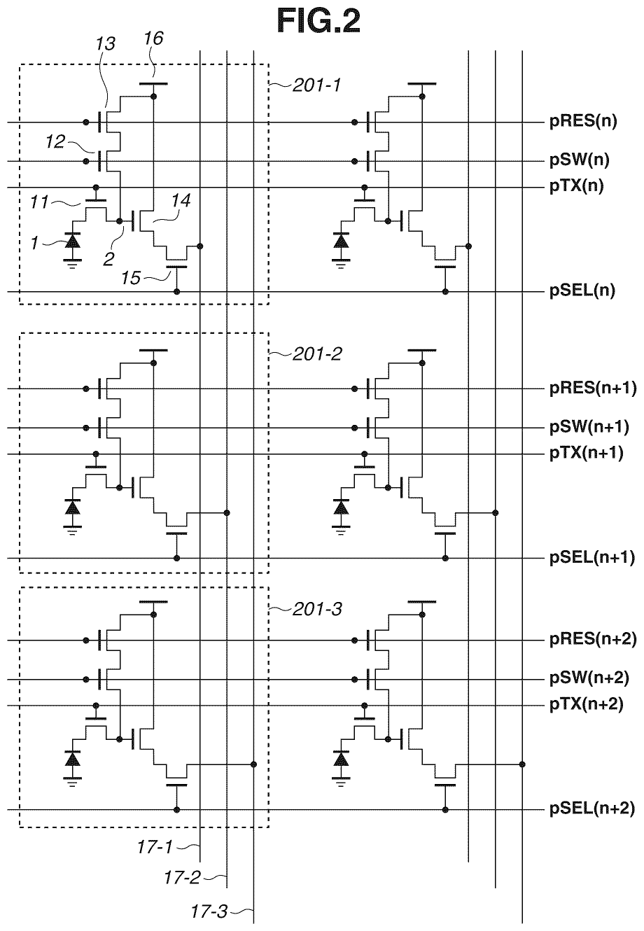

FIG. 2 is an equivalent circuit diagram of pixels included in the photoelectric conversion region 102. For the sake of simplicity, FIG. 2 illustrates a configuration of three rows and two columns of pixels among the plurality of pixels arranged in the plurality of rows and the plurality of columns. However, the number of pixels is not limited thereto. While three signal lines 17-1, 17-2, and 17-3 are included in a column, the number of signal lines is not limited thereto. In FIG. 2, the signal lines 17 are extended in the column direction, whereas the signal lines 17 may be extended in the row direction.

Each pixel 201 includes a photoelectric conversion unit 1, a floating diffusion portion 2, and a transfer unit 11 located between the photoelectric conversion unit 1 and the floating diffusion portion 2. The pixel 201 also includes a capacitance switching unit 12 for switching the capacitance of the floating diffusion portion 2 as appropriate. The pixel 201 further includes a reset unit 13 for resetting the floating diffusion portion 2, and an amplification unit 14 for outputting the signal of the floating diffusion portion 2. The pixel 201 further includes a selection unit (row selection unit) 15 that controls signal output from the amplification unit 14 to a signal line 17. Each of the transfer unit 11, the capacitance switching unit 12, the reset unit 13, the amplification unit 14, and the selection unit 15 is typically a metal-oxide-silicon (MOS) transistor. However, such a configuration is not restrictive. In the following exemplary embodiments, the transistors will be described as N-type MOS transistors. However, as described above, the conductivity types can be changed where appropriate.

The photoelectric conversion unit 1 receives light incident on the pixel 201 and generates an electric charge corresponding to the amount of light received. For example, a photodiode can be used as the photoelectric conversion unit 1. The floating diffusion portion 2 temporarily stores the charge transferred from the photoelectric conversion unit 1, and simultaneously functions as a charge-voltage conversion unit that converts the stored charge into a voltage signal.

The transfer unit 11 is driven by a transfer unit drive pulse pTX to transfer the charge generated by the photoelectric conversion unit 1 to the floating diffusion portion 2.

The capacitance switching unit 12 is driven by a floating diffusion capacitance switch pulse pSW to switch the capacitance of the floating diffusion portion 2. Turning the capacitance switching unit 12 on can add the gate capacitance of the capacitance switching unit 12 to the floating diffusion portion 2.

The reset unit 13 is driven by a reset unit drive pulse pRES. Turning on the reset unit 13 and the capacitance switching unit 12 at the same time can reset the floating diffusion portion 2.

The amplification unit 14 amplifies the voltage signal converted by the floating diffusion portion 2 and outputs the amplified voltage signal as a pixel signal.

The selection unit 15 is driven by a selection drive pulse pSEL to output the pixel signal amplified by the amplification unit 14 to one of the signal lines 17-1, 17-2, and 17-3. In the present exemplary embodiment, since the signal lines 17 are vertical signal lines extending in the virtual direction, the selection unit 15 is a row selection unit to be driven by a row selection drive pulse.

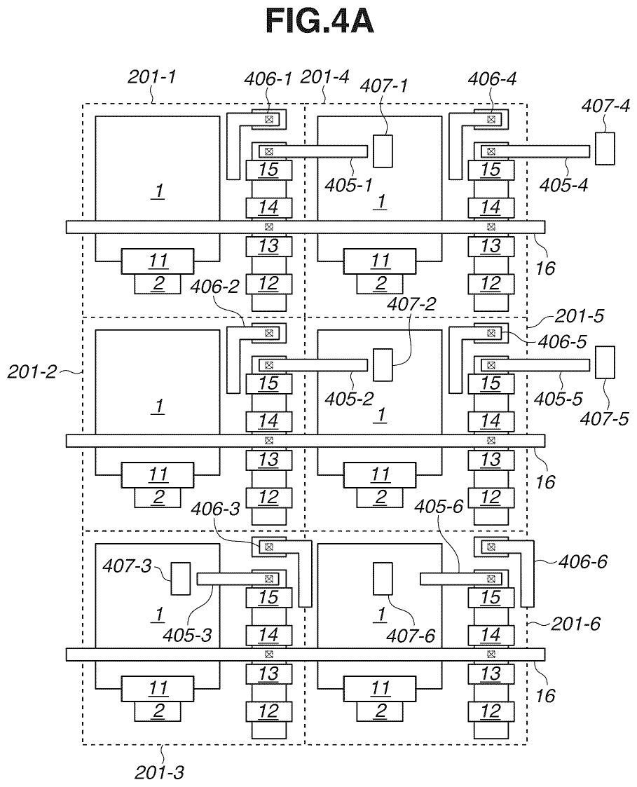

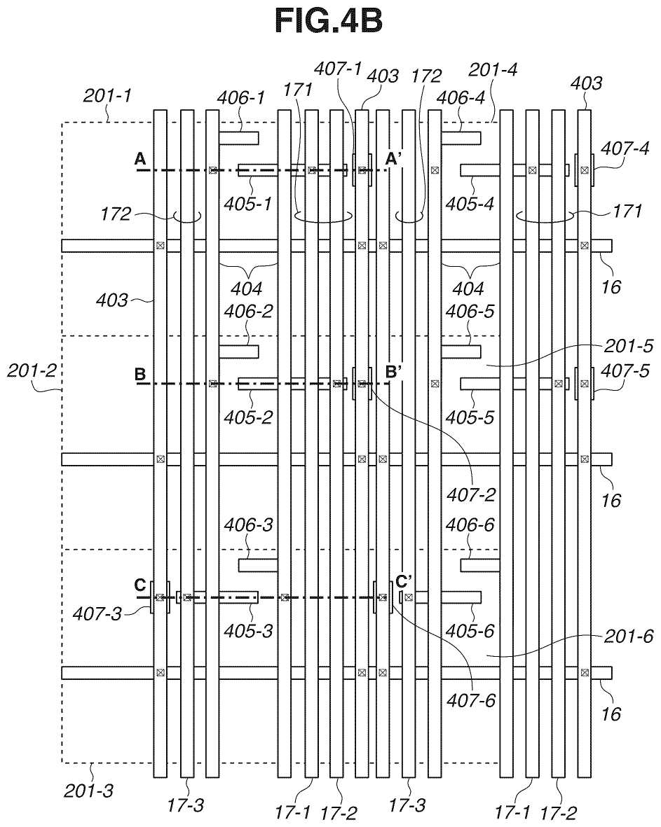

A plurality of rows constituted by a plurality of pixels 201 includes a first group row and a second group row. The first group row and the second group row are respective different rows. In FIGS. 2, 4A, and 4B, the rows including pixels 201-1 and 201-2 are referred to as the first group row, and the row including a pixel 201-3 is referred to as the second group row. However, this is not necessarily restrictive. The pixel 201-2 of the first group row will be referred to as a pixel (first pixel) located at a first column and a first row. The pixel 201-3 of the second group row will be referred to as a pixel (second pixel) located at the first column and a second row different from the first row. A second column adjoining the first column includes a pixel 201-4, a pixel 201-5 (third pixel), and a pixel 201-6. The pixel 201-5 is located at the second column and the second row. In other words, the third pixel is located to adjoin the second pixel. The pixels 201-1 and 201-2 of the first group row can be used to generate image signals for recording, for example.

The pixel 201-3 of the second group row can be used to generate an image signal for display, for example. While the following description will be given on the assumption that the obtained image signals are used as described above, the uses of the obtained image signals are not limited to the foregoing example. For example, the pixels 201-1 and 201-2 of the first group row may be used to generate image signals for moving image display, and the pixel 201-3 of the second group row may be used to generate an image signal for sensing.

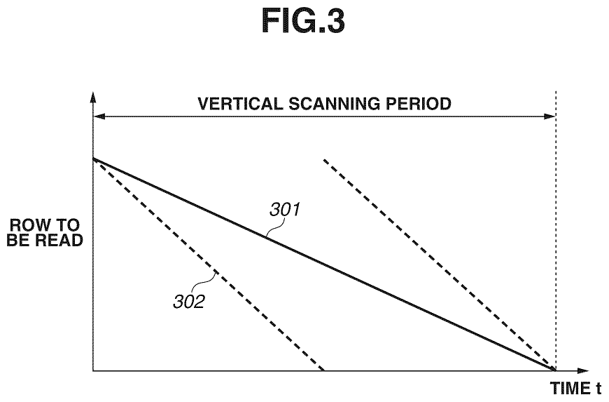

The horizontal axis of FIG. 3 indicates time t in a vertical scanning period, and the vertical axis indicates a row of pixels to be read among a plurality of rows. A solid line 301 represents a scan for reading image signals for recording from the photoelectric conversion units 1 in the first group row, which is referred to as a first scan. Dotted lines 302 represent a scan for reading image signals for display from the photoelectric conversion units 1 in the second group row, which is referred to as a second scan. In the example of FIG. 2, the two signal lines 17-1 and 17-2 among the three signal lines 17 disposed in each column are used for the first scan. The one or more signal lines 17 to be used for the first scan are referred to as a first signal line group 171. The signal line 17-3 among the three signal lines 17 disposed in each column is used for the second scan. The one or more signal lines 17 to be used for the second scan are referred to as a second signal line group 172. In a predetermined mode, the image signals for recording from the pixels 201-1 and 201-2 in a plurality of first group rows and the image signals for display from the pixels 201-3 in a plurality of second group rows can be read at the same time.

In the present exemplary embodiment, the number of pixel rows in a first group row for use in the first scan is greater than the number of pixel rows in a second group row for use in the second scan. In other words, the number of signal lines 17 constituting a first signal line group 171 is greater than the number of signal lines 17 constituting a second signal line group 172. Note that the number of pixel rows in a first group row and the number of pixel rows in a second group row may be the same. The number of pixel rows in a first group row may be smaller than the number of pixel rows in a second group row.

FIG. 4A is a plan view of pixels 201 according to the first exemplary embodiment, illustrating two columns and three columns of pixels 201. FIG. 4A illustrates the layout of diffusion regions and transistor gates on a semiconductor layer, and a part of a first wiring layer located above the semiconductor layer. In the present exemplary embodiment, the photoelectric conversion apparatus 101 is a back-illumination photoelectric conversion apparatus that is illuminated with light from below the semiconductor layer, i.e., from the side opposite to where the first wiring layer is disposed on the semiconductor layer. The photoelectric conversion apparatus 101 according to the present exemplary embodiment may be a front-illumination photoelectric conversion apparatus that is illuminated with light from the side where the first wiring layer is disposed. In FIGS. 4A and 4B, elements similar or corresponding to those illustrated in FIG. 2 are denoted by the same reference numerals. In FIGS. 4A and 4B, each region is represented by a rectangle for the sake of simplicity. However, the shapes of the parts are not limited thereto, and the regions indicate that the parts are at least disposed therein.

The diffusion regions of the floating diffusion portions 2 are constituted by the drain regions of the transistors constituting the transfer units 11. The drain regions of the transfer units 11 are connected to the drain regions of the capacitance switching units 12 by wiring.

The first wiring layer includes connection wiring 405 for connecting to at least one of the signal lines 17. In a plan view, the connection wiring 405 extends in a direction orthogonal to the direction in which the signal lines 17 extend on a second wiring layer to be described below. The first wiring layer also includes power supply wiring 16 for supplying a power supply voltage (VDD) that is a fixed potential. The power supply wiring 16 is connected to the reset units 13 and the amplification units 14. Shield wiring 406 (third shield wiring) and shield wiring 407 (fourth shield wiring) are further provided as appropriate. Fixed potentials are supplied to the shield wiring 406 and the shield wiring 407. In the present exemplary embodiment, a ground voltage (GND) is supplied to the shield wiring 406 via the semiconductor layer. The power supply voltage (VDD) is supplied to the shield wiring 407. The shield wiring 406 is connected to the semiconductor layer. The shield wiring 406 is connected to shield wiring 404 (second shield wiring) on the second wiring layer to be described below.

The shield wiring 407 is connected to shield wiring 403 (first shield wiring) on the second wiring layer to be described below.

As illustrated in FIG. 4A, in the pixels 201-1 and 201-2 of the first group row, connection wiring 405-1 and 405-2 extends away from the photoelectric conversion units 1 (to the right) in a plan view. In the pixel 201-3 of the second group row, connection wiring 405-3 extends toward the photoelectric conversion unit 1 (to the left) in a plan view.

In the pixels 201-1 and 201-2 of the first group row, shield wiring 406-1 and 406-2 is located in part between the connection wiring 405 and the photoelectric conversion units 1. In the pixel 201-3 of the second group row, shield wiring 406-3 is located in part between the connection wiring 405-3 and the photoelectric conversion unit 1 of the adjoining pixel.

Relative to the side where the shield wiring 406 is disposed, the shield wiring 407 is located on the opposite side in the extending direction of the connection wiring 405 in a plan view.

The connection wiring 405, the shield wiring 406, and the shield wiring 407 of the first group row, and the connection wiring 405, the shield wiring 406, and the shield wiring 407 of the second group row are arranged in a line-symmetrical manner with the gate length direction of the amplification units 14 as the axis. More specifically, the connection wiring 405-1 and 405-2 of the first group row and the connection wiring 405-3 of the second group row are arranged in a line-symmetrical manner. The shield wiring 406-1 and 406-2 of the first group row and the shield wiring 406-3 of the second group row are arranged in a line-symmetrical manner. Shield wiring 407-1 and 407-2 of the first group row and shield wiring 407-3 of the second group row are arranged in a line-symmetrical manner.

FIG. 4B is a plan view of the pixels 201 according to the first exemplary embodiment. FIG. 4B illustrates the layout of the first wiring layer illustrated in FIG. 4A and the second wiring layer disposed on the first wiring layer. The second wiring layer includes first signal line groups 171, second signal line groups 172, and shield wiring 403 parallel to the signal lines. The layer where the first and second signal line groups 171 and 172 are disposed and the wiring layer where the connection wiring 405 is disposed are located to adjoin each other.

For example, if the connection wiring 405 is disposed on the first wiring layer, the layer where the signal line groups 171 and 172 are disposed is the second wiring layer. If the connection wiring 405 is disposed on the second wiring layer, the layer where the signal line groups 171 and 172 are disposed is the first wiring layer or a third wiring layer. The shield wiring 403 is located between the first signal line group 171 of a pixel column and the second signal line group 172 of an adjoining pixel column in a plan view. In other words, the first shield wiring is located between a first signal line group 171 and a second signal line group 172 including a third signal line connected to the third pixel. The shield wiring 404 is disposed as appropriate between the first signal line group 171 and the second signal line group 172 that are included in a pixel row, in parallel with the signal lines 17. In the present exemplary embodiment, the first signal line group 171 and the second signal line group 172 include portions disposed on the second wiring layer (first layer), and the shield wiring 404 is located between the signal line groups 171 and 172 on the second wiring layer. For example, shield wiring 404 extending in parallel with the signal lines 17 and to which a fixed potential is supplied is located between the first signal line group 171 and the second signal line group 172 including a second signal line connected to the second pixel.

Fixed potentials are supplied to the shield wiring 403 and the shield wiring 404. In the present exemplary embodiment, the ground voltage (GND) is supplied to the shield wiring 404 via the shield wiring 406. The power supply voltage (VDD) is supplied to the shield wiring 403 via the shield wiring 407. While the number of contact plugs illustrated to be connected between an amplification unit 14 and the power supply wiring 16 is one, the number of such contact plugs is two or more. In one embodiment, the length in the lateral direction of the contact plug(s) connected to the amplification unit 14 is longer than the length of the contact plug(s) connected to the selection unit 15, and the total area of the contact plug(s) connected to the amplification unit 14 is greater than the total area of the contact plug(s) connected to the selection unit 15. For example, the contact plugs connected to the amplification unit 14 are laterally arranged, and the number of contact plugs connected to the amplification unit 14 is made greater than the number of contact plugs connected to the selection unit 15. This can reduce the parasitic capacitance occurring in the floating diffusion portion 2.

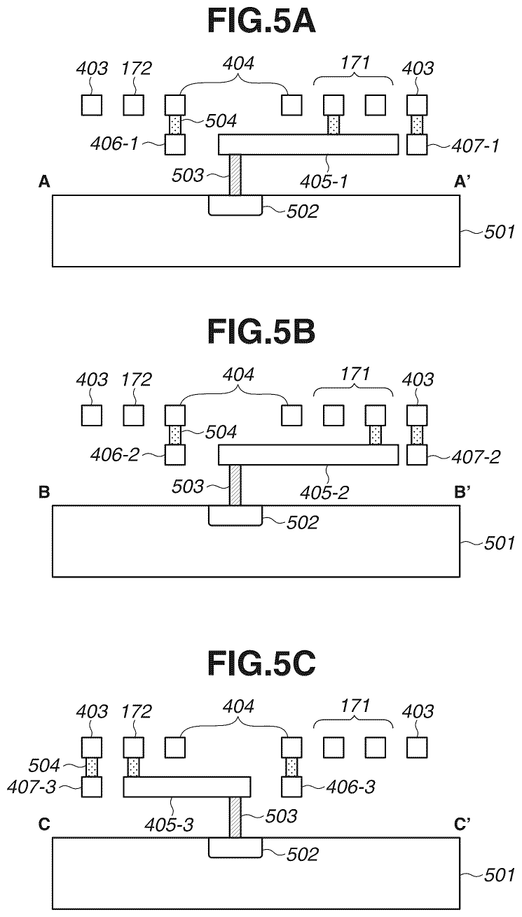

FIG. 5A is a sectional view taken along line A-A′ of FIG. 4B. The connection wiring 405-1 is connected to a source region 502 of the selection unit 15 disposed in a semiconductor layer 501 via a contact 503. The connection wiring 405-1 is located to overlap the first signal line group 171 and not the second signal line group 172 in a plan view. The shield wiring 406-1 is located to overlap the shield wiring 404, at least in part, in a plan view. The shield wiring 406-1 may be connected to the shield wiring 404 through a via 504 as appropriate. The shield wiring 407-1 is located to overlap the shield wiring 403 in a plan view. The shield wiring 407-1 may be connected to the shield wiring 403 through a via 504 as appropriate.

FIG. 5B is a sectional view taken along line B-B′ of FIG. 4B. The connection wiring 405-2 is connected to the source region 502 of the selection unit 15 disposed in the semiconductor layer 501 via a contact 503. The connection wiring 405-2 is located to overlap the first signal line group 171 and not the second signal line group 172 in a plan view. The shield wiring 406-2 is located to overlap the shield wiring 404, at least in part, in a plan view. The shield wiring 406-2 may be connected to the shield wiring 404 through a via 504 as appropriate. The shield wiring 407-2 is located to overlap the shield wiring 403 in a plan view. The shield wiring 407-2 may be connected to the shield wiring 403 through a via 504 as appropriate.

FIG. 5C is a sectional view taken along line C-C′ of FIG. 4B. The connection wiring 405-3 is connected to the source region 502 of the selection unit 15 disposed in the semiconductor layer 501 via a contact 503. The connection wiring 405-3 is located to overlap the second signal line group 172 and not the first signal line group 171 in a plan view. The shield wiring 406-3 is located to overlap the shield wiring 404, at least in part, in a plan view. The shield wiring 406-3 may be connected to the shield wiring 404 through a via 504 as appropriate. The shield wiring 407-3 is located to overlap the shield wiring 403 in a plan view. The shield wiring 407-3 may be connected to the shield wiring 403 through a via 504 as appropriate.

In the present exemplary embodiment, the connection wiring 405-1 and 405-2 of the first group row and the second signal line group 172 are located to not overlap in a plan view. The connection wiring 405-3 of the second group row and the first signal line group 171 are located to not overlap in a plan view. This can reduce the parasitic capacitance between the connection wiring 405-1 and 405-2 of the first group row and the second signal line group 172 and the parasitic capacitance between the connection wiring 405-3 of the second group row and the first signal line group 171. As a result, in the photoelectric conversion apparatus having a mode where a plurality of different vertical scans is simultaneously performed in parallel, crosstalk that occurs during reading in the mode can be reduced to improve image quality.

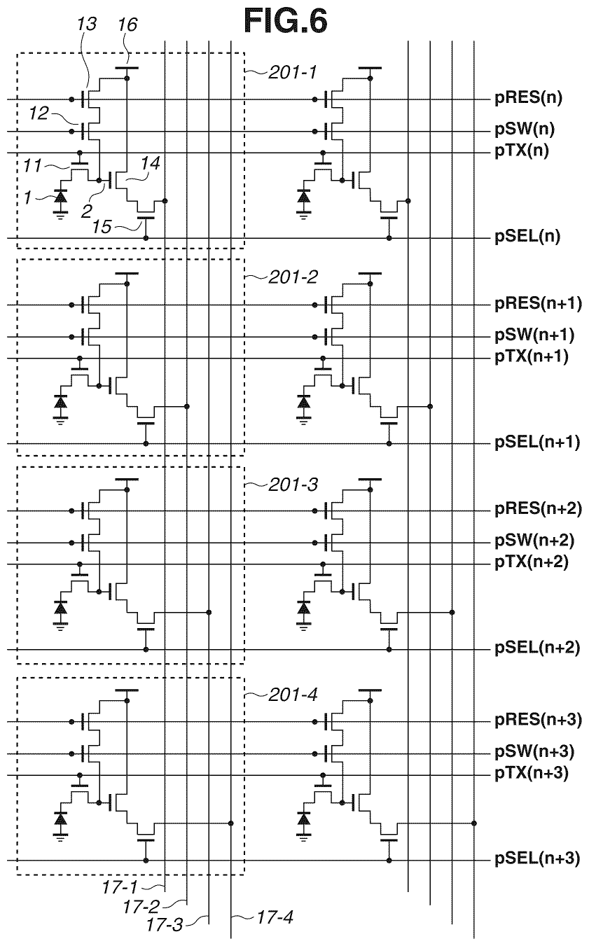

FIG. 6 is an equivalent circuit diagram of pixels 201 included in a photoelectric conversion region 102 according to a second exemplary embodiment.

The present exemplary embodiment differs from the first exemplary embodiment in that a plurality of pixel rows includes a third group row in addition to first and second group rows. In other respects, the present exemplary embodiment has substantially the same structure as that of the first exemplary embodiment. Differences from the first exemplary embodiment will hereinafter be described, and a description of the same structure as that of the first exemplary embodiment will be omitted as appropriate.

For the sake of simplicity, FIG. 6 illustrates a four-row two-column configuration. However, the number of pixels is not limited thereto. While four signal lines 17-1, 17-2, 17-3, and 17-4 are disposed for a column, the number of signal lines is not limited thereto.

The plurality of pixel rows constituted by the plurality of pixels 201 includes a first group row, a second group row, and a third group row. The first, second, and third group rows are respective different rows. In FIG. 6, the rows including pixels 201-1 and 201-2 are referred to as a first group row. The row including a pixel 201-3 is referred to as a second group row. The row including a pixel 201-4 is referred to as a third group row. However, this is not necessarily restrictive. The pixels 201-1 and 201-2 of the first group row can be used to generate image signals for recording, for example. The pixel 201-3 of the second group row can be used to generate an image signal for display, for example. The pixel 201-4 of the third group row can be left unread, for example. The pixel 201-4 of the third group row will be referred to as a pixel (fourth pixel) located at the first column and a third row different from the first or second row. The functions of the respective group rows and the uses of the obtained image signals are not limited to the foregoing example.

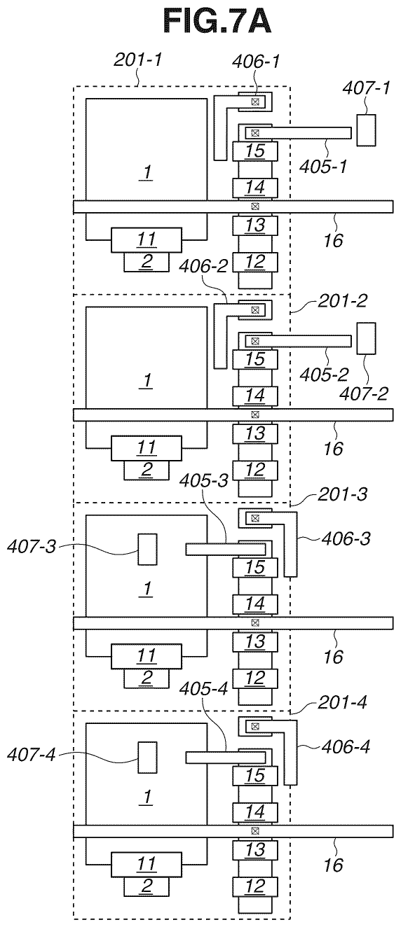

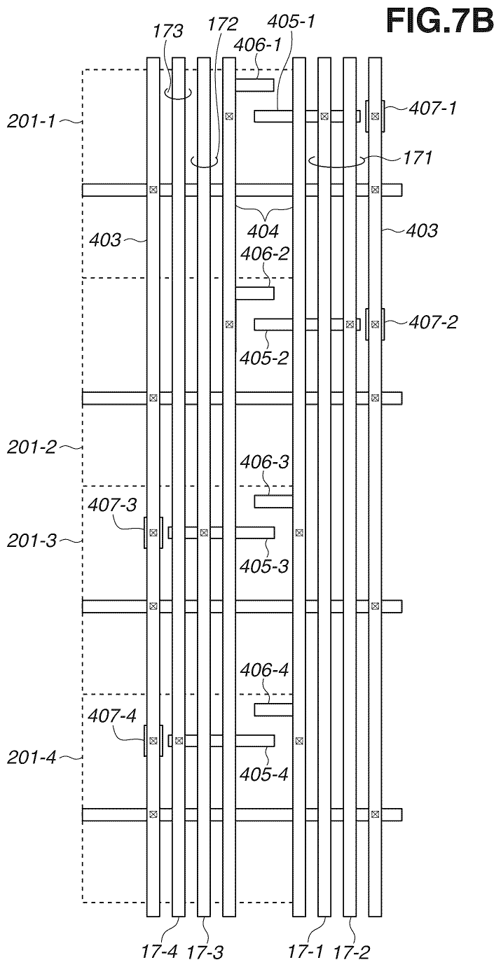

FIG. 7A is a plan view of the pixels 201 according to the second exemplary embodiment. FIG. 7A illustrates the layout of diffusion regions and transistor gates on a semiconductor layer, and a part of a first wiring layer located above the semiconductor layer.

The first wiring layer includes connection wiring 405 to be connected to at least one of the signal lines 17. The connection wiring 405 extends in a direction orthogonal to the signal lines 17 on a second wiring layer to be described below in a plan view. The first wiring layer also includes power supply wiring 16 for supplying a power supply voltage VDD that is a fixed potential. The power supply wiring 16 is connected to reset units 13 and amplification units 14. Shield wiring 406 and shield wiring 407 are disposed as appropriate.

Connection wiring 405-4 and shield wiring 406-4 and 407-4 of the third group row are disposed to overlap connection wiring 405-3 and shield wiring 406-3 and 407-3 of the second group row in a plan view by translating the connection wiring 405-3 and the shield wiring 406-3 and 407-3.

FIG. 7B is a plan view of the pixels 201 according to the second exemplary embodiment. FIG. 7B illustrates the layout of the first wiring layer illustrated in FIG. 7A and a second wiring layer disposed on the first wiring layer. The second wiring layer includes a first signal line group 171, a second signal line group 172, a third signal line group 173, and shield wiring 403 parallel to the signal lines. The third signal line group 173 includes the fourth signal line 17-4, which is connected to the fourth pixel.

In a mode where a first vertical scan and a second vertical scan are simultaneously performed in parallel, a fixed potential is supplied to the signal line constituting the third signal line group 173 at least when the first and second virtual scans are performed. For that purpose, the third signal line group 173 is connected to wiring or a diffusion region of the semiconductor layer so that the fixed potential is supplied thereto. Shield wiring 404 is disposed as appropriate between the first and second signal line groups 171 and 172, in parallel with the signal lines 17.

In the present exemplary embodiment, the connection wiring 405-1 and 405-2 of the first group row and the second signal line group 172 are located to not overlap in a plan view. The connection wiring 405-3 of the second group row and the first signal line group 171 are located to not overlap in a plan view. This can reduce the parasitic capacitance between the connection wiring 405-1 and 405-2 of the first group row and the second signal line group 172 and the parasitic capacitance between the connection wiring 405-3 of the second group row and the first signal line group 171. As a result, crosstalk that occurs during reading in the mode where a plurality of different vertical scans is simultaneously performed in parallel can be reduced to improve image quality.

According to the present exemplary embodiment, in the mode where the first vertical scan and the second vertical scan are simultaneously performed in parallel, a fixed potential is supplied to the third signal line group 173. This can reduce crosstalk due to the potential of the third signal line group 173, and improve image quality.

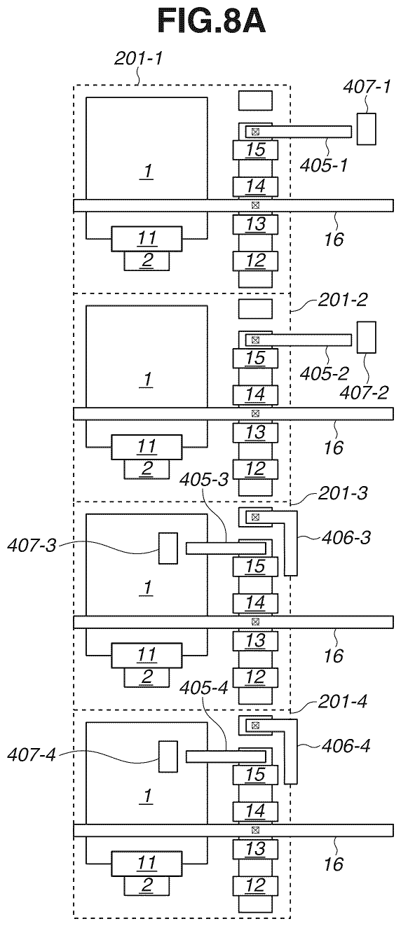

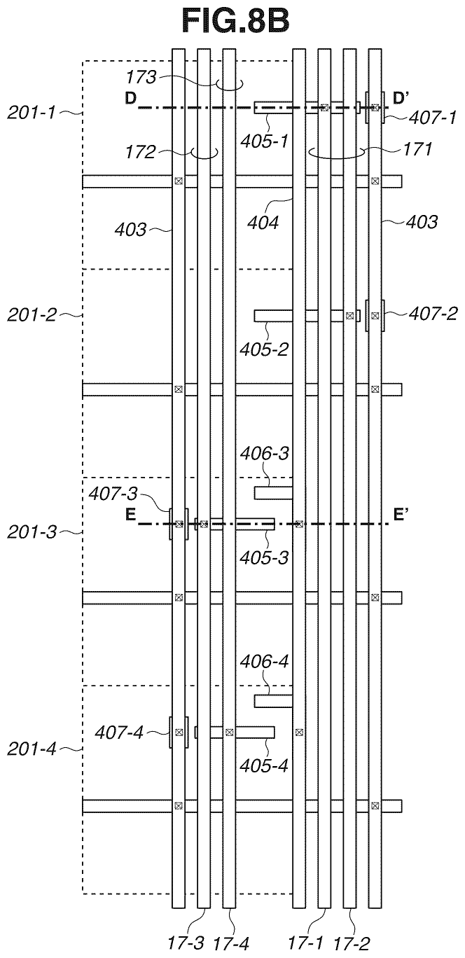

FIGS. 8A and 8B are plan views of pixels 201 according to a third exemplary embodiment. The present exemplary embodiment differs from the second exemplary embodiment in that the third signal line group 173 is located between the first signal line group 171 and the second signal line group 172, and that the shield wiring 406 is not disposed for the pixels 201 of the first group row. In other respects, the present exemplary embodiment has substantially the same structure as that of the second exemplary embodiment. Differences from the second exemplary embodiment will hereinafter be described, and a description of the same structure as that of the second exemplary embodiment will be omitted as appropriate.

FIG. 8A is a plan view of the pixels 201 according to the third exemplary embodiment. FIG. 8A illustrates the layout of diffusion regions and transistor gates on a semiconductor layer and a part of a first wiring layer located above the semiconductor layer. The first wiring layer includes connection wiring 405 that is located to be orthogonal to at least either one of the first and second signal line groups 171 and 172 in a plan view and connected to at least one of the signal lines 17. Shield wiring 406 and shield wiring 407 are disposed as appropriate.

Pixels 201-1 and 201-2 of a first group row do not include shield wiring 406-1 or 406-2. A pixel 201-3 of a second group row includes shield wiring 406-3. A pixel 201-4 of a third group row includes shield wiring 406-4.

FIG. 8B is a plan view of the pixels 201 according to the third exemplary embodiment. FIG. 8B illustrates the layout of the first wiring layer illustrated in FIG. 8A and a second wiring layer disposed on the first wiring layer. The second wiring layer includes the first signal line group 171, the second signal line group 172, the third signal line group 173, and shield wiring 403 parallel to the signal lines 17. The third signal line group 173 is located between the first signal line group 171 and the second signal line group 172. In a mode where a first vertical scan and a second vertical scan are simultaneously performed in parallel, a fixed potential is supplied to the third signal line group 173 at least while the first and second vertical scans are performed. Shield wiring 404 is disposed as appropriate between the first signal line group 171 and the second signal line group 172, in parallel with the signal lines 17. In the second exemplary embodiment, two wires of shield wiring 404 are located between the first signal line group 171 and the second signal line group 172. In the present exemplary embodiment, a single wire of shield wiring 404 is located therebetween. According to the present exemplary embodiment, the number of wires can be reduced to reduce the wiring area for easy pixel miniaturization.

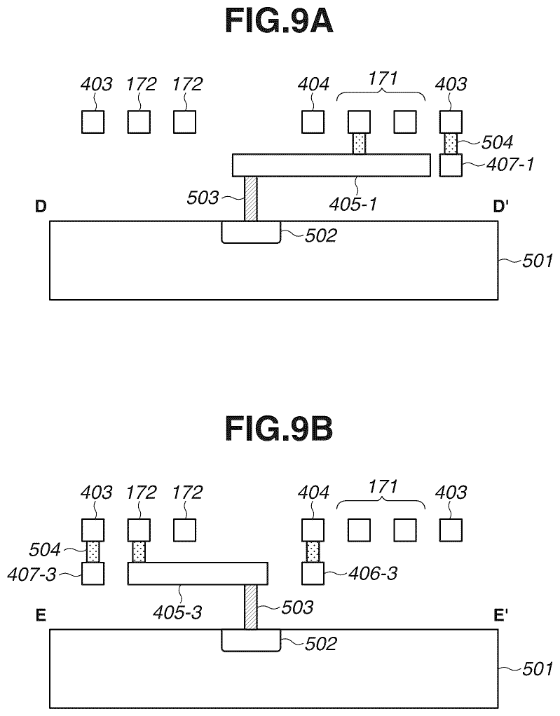

FIG. 9A is a sectional view taken along line D-D′ of FIG. 8B. Connection wiring 405-1 is connected to the source region 502 of the selection unit 15 disposed in the semiconductor layer 501 via a contact 503. The connection wiring 405-1 is located to overlap the first signal line group 171 and not the second signal line group 172 in a plan view. The shield wiring 403 is located to overlap shield wiring 407-1 in a plan view. The shield wiring 403 may be connected to the shield wiring 407-1 through a via 504 as appropriate.

FIG. 9B is a sectional view taken along line E-E′ of FIG. 8B. Connection wiring 405-3 is connected to the source region 502 of the selection unit 15 disposed in the semiconductor layer 501 via a contact 503. The connection wiring 405-3 is located to overlap the second signal line group 172 and not the first signal line group 171 in a plan view. The shield wiring 404 is located to overlap the shield wiring 406-3, at least in part, in a plan view. The shield wiring 404 may be connected to the shield wiring 406-3 through a via 504 as appropriate. Shield wiring 407-3 is located to overlap the shield wiring 403 in a plan view. The shield wiring 407-3 may be connected to the shield wiring 403 through a via 504 as appropriate.

In the present exemplary embodiment, the connection wiring 405-1 and 405-2 of the first group row and the second signal line group 172 are located to not overlap in a plan view. The connection wiring 405-3 of the second group row and the first signal line group 171 are located to not overlap in a plan view. This can reduce the parasitic capacitance between the connecting wiring 405-1 and 405-2 of the first group row and the second signal line group 172 and the parasitic capacitance between the connection wiring 405-3 of the second group row and the first signal line group 171. As a result, crosstalk that occurs during reading in the mode where a plurality of different types of vertical scans is simultaneously performed in parallel can be reduced to improve image quality.

In the present exemplary embodiment, in the mode where the first vertical scan and the second vertical scan are simultaneously performed in parallel, a fixed potential is supplied to the third signal line group 173. This can reduce crosstalk due to the potential of the third signal line group 173 for improved image quality.

Moreover, the number of wires of the shield wiring 404 can be reduced compared to the second exemplary embodiment. This can reduce the area of the shield wiring 404 and enables miniaturization.

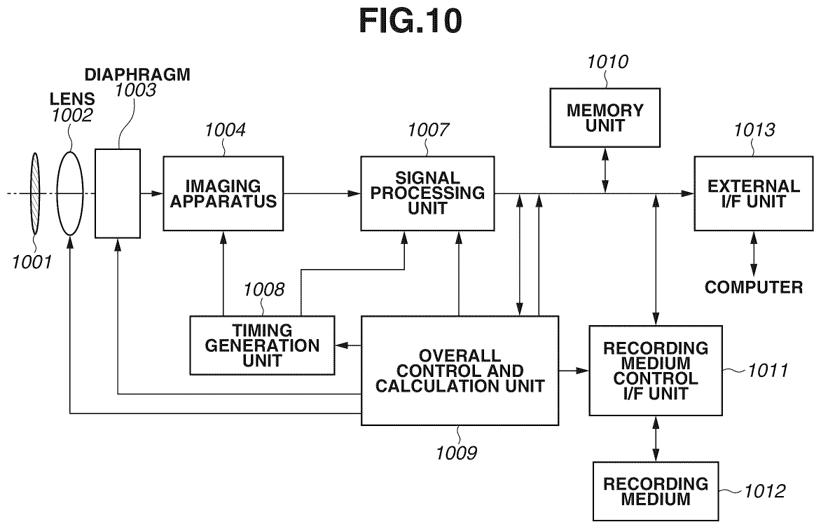

A photoelectric conversion system according to a fourth exemplary embodiment will be described with reference to FIG. 10. FIG. 10 is a block diagram illustrating a schematic configuration of the photoelectric conversion system according to the present exemplary embodiment.

The photoelectric conversion apparatuses (imaging apparatuses) described in the first to third exemplary embodiments can be applied to various photoelectric conversion systems. Examples of the applicable photoelectric conversion systems include a digital still camera, a digital camcorder, a surveillance camera, a copying machine, a facsimile, a mobile phone, an in-vehicle camera, and an observation satellite. A camera module including an optical system, such as a lens, and an imaging apparatus is also included in the photoelectric conversion systems. FIG. 10 illustrates a block diagram of a digital still camera as an example of these.

The photoelectric conversion system illustrated in FIG. 10 includes an imaging apparatus 1004 that is an example of the photoelectric conversion apparatus, and a lens 1002 that forms an optical image of an object on the imaging apparatus 1004. The photoelectric conversion system further includes a diaphragm 1003 for changing the amount of light to pass through the lens 1002, and a barrier 1001 for protecting the lens 1002. The lens 1002 and the diaphragm 1003 constitute an optical system for collecting light to the imaging apparatus 1004. The imaging apparatus 1004 is the photoelectric conversion apparatus (imaging apparatus) described in one of the first to third exemplary embodiments, and converts the optical image formed by the lens 1002 into an electrical signal.

The photoelectric conversion system also includes a signal processing unit 1007 that is an image generation unit for generating an image by processing an output signal output from the imaging apparatus 1004. The signal processing unit 1007 performs various types of correction and compression as appropriate and outputs image data. The signal processing unit 1007 may be formed on a semiconductor substrate where the imaging apparatus 1004 is disposed, or on a semiconductor substrate different from where the imaging apparatus 1004 is disposed. The imaging apparatus 1004 and the signal processing unit 1007 may be formed on the same semiconductor substrate.

The photoelectric conversion system further includes a memory unit 1010 for temporarily storing image data, and an external interface (I/F) unit 1013 for communicating with an external computer. The photoelectric conversion system further includes a recording medium 1012, such as a semiconductor memory, for recording and reading captured data, and a recording medium control I/F unit 1011 for recording and reading the captured data on/from the recording medium 1012. The recording medium 1012 may be built in the photoelectric conversion system, or detachably attachable to the photoelectric conversion system.

The photoelectric conversion system further includes an overall control and calculation unit 1009 that controls various types of calculation and the entire digital still camera, and a timing generation unit 1008 that outputs various timing signals to the imaging apparatus 1004 and the signal processing unit 1007. The timing signals may be input from outside, and the photoelectric conversion system can include at least the imaging apparatus 1004 and the signal processing unit 1007 that processes the output signal output from the imaging apparatus 1004.

The imaging apparatus 1004 outputs an imaging signal to the signal processing unit 1007. The signal processing unit 1007 performs predetermined signal processing on the imaging signal output from the imaging apparatus 1004, and outputs image data. The signal processing unit 1007 generates an image using the imaging signal.

As described above, according to the present exemplary embodiment, a photoelectric conversion system to which the photoelectric conversion apparatus (imaging apparatus) according to one of the foregoing exemplary embodiments is applied can be implemented.

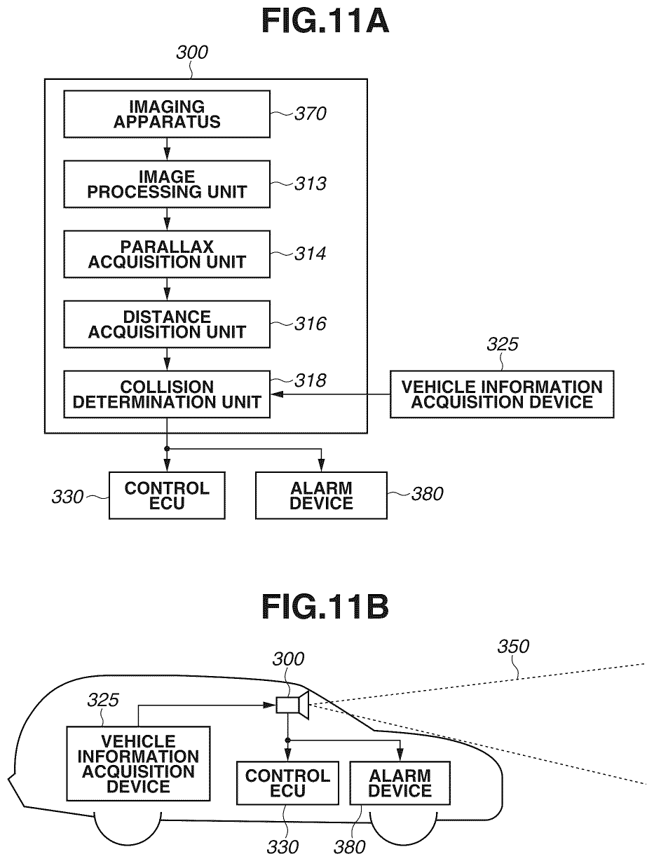

A photoelectric conversion system and a moving body according to a fifth exemplary embodiment will be described with reference to FIGS. 11A and 11B. FIG. 11A and 11B are diagrams illustrating a configuration of the photoelectric conversion system and the moving body according to the present exemplary embodiment.

FIG. 11A illustrates an example of a photoelectric conversion system related to an in-vehicle camera. A photoelectric conversion system 300 includes an imaging apparatus 370. The imaging apparatus 370 is the photoelectric conversion apparatus (imaging apparatus) described in one of the first to third exemplary embodiments. The photoelectric conversion system 300 includes an image processing unit 313 that performs image processing on a plurality of pieces of image data obtained by the imaging apparatus 370, and a parallax acquisition unit 314 that calculates a parallax (phase difference between parallax images) from the plurality of pieces of image data obtained using the imaging apparatus 370. The photoelectric conversion system 300 further includes a distance acquisition unit 316 that calculates a distance to an object based on the calculated parallax, and a collision determination unit 318 that determines whether there is a possibility of collision based on the calculated distance. The parallax acquisition unit 314 and the distance acquisition unit 316 are examples of a distance information acquisition unit that acquires distance information about an object. In other words, the distance information refers to information about a parallax, a defocus amount, a distance to an object, etc. The collision determination unit 318 may determine the possibility of collision using any of these pieces of distance information. The distance information acquisition unit may be implemented by a dedicatedly designed piece of hardware or by a software module. A field-programmable gate array (FPGA) or application-specific integrated circuit (ASIC) may be used for implementation. A combination of these may be used for implementation.

The photoelectric conversion system 300 is connected to a vehicle information acquisition device 325, and can acquire vehicle information such as a vehicle speed, yaw rate, and steering angle. The photoelectric conversion system 300 is also connected to a control electronic control unit (ECU) 330. The control ECU 330 is a control device that outputs a control signal to generate braking force on the vehicle based on the determination result of the collision determination unit 318. The photoelectric conversion system 300 is also connected to an alarm device 380 that issues an alarm to the driver based on the determination result of the collision determination unit 318. For example, if the determination result of the collision determination unit 318 indicates a high possibility of collision, the control ECU 330 performs vehicle control to avoid the collision or reduce damage by applying the brake, releasing the accelerator, and/or reducing the engine output. The alarm device 380 warns the user (driver) by sounding an alarm, displaying alarm information on the screen of a car navigation system, and/or vibrating the seat belt or the steering wheel.

In the present exemplary embodiment, the photoelectric conversion system 300 captures images of the surroundings of the vehicle, such as in front of or behind the vehicle. FIG. 11B illustrates the photoelectric conversion system 300 in the case of capturing images in front of the vehicle (imaging range 350). The vehicle information acquisition device 325 transmits instructions to the photoelectric conversion system 300 or the imaging apparatus 370. With such a configuration, the accuracy of distance measurement can be improved.

The foregoing description has dealt with an example where the vehicle is controlled to prevent collision with other vehicles. However, the photoelectric conversion system 300 according to the present exemplary embodiment can also be applied to automatic driving control to follow another vehicle or automatic driving control to stay in the lane. The photoelectric conversion system 300 is not limited to a vehicle such as one's own vehicle, and may be applied to a moving body (moving device) such as a ship, an aircraft, and an industrial robot. This moving body includes either one of or both a driving force generation unit that generates driving force to be mainly used to move the moving body and a rotating body that is mainly used to move the moving body. Examples of the driving force generation unit may include an engine and a motor. Examples of the rotating body may include a tire, a wheel, a ship screw, and an aircraft propeller. The photoelectric conversion system 300 according to the present exemplary embodiment is not limited to a moving body, either, and can be widely applied to devices that use object recognition, like an intelligent transportation system (ITS).

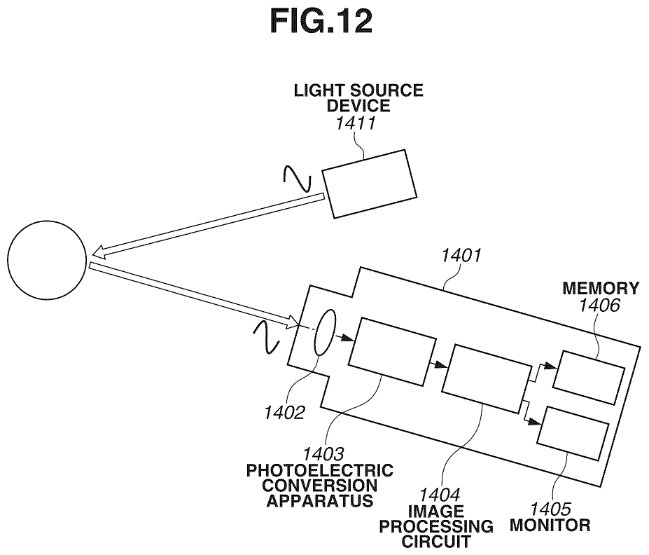

A photoelectric conversion system according to a sixth exemplary embodiment will be described with reference to FIG. 12. FIG. 12 is a block diagram illustrating a configuration example of a distance image sensor that is the photoelectric conversion system according to the present exemplary embodiment.

As illustrated in FIG. 12, a distance image sensor 1401 includes an optical system 1402, a photoelectric conversion apparatus 1403, an image processing circuit 1404, a monitor 1405, and a memory 1406. The distance image sensor 1401 can obtain a distance image corresponding to a distance to an object by receiving light (modulated light or pulsed light) that is projected from a light source device 1411 upon the object and reflected at the surface of the object.

The optical system 1402 includes one or more lenses. The optical system 1402 guides the image light (incident light) from the object to the photoelectric conversion apparatus 1403 and forms an image on the light receiving surface (sensor part) of the photoelectric conversion apparatus 1403.

The photoelectric conversion apparatus described in one of the first to third exemplary embodiments is applied to the photoelectric conversion apparatus 1403. A distance signal indicating the distance determined from a light reception signal output from the photoelectric conversion apparatus 1403 is supplied to the image processing circuit 1404.

The image processing circuit 1404 performs image processing for constructing a distance image based on the distance signal supplied from the photoelectric conversion apparatus 1403. The distance image (image data) obtained by the image processing is supplied to and displayed on the monitor 1405, or supplied to and stored in (recorded on) the memory 1406.

The distance image sensor 1401 configured thus can obtain a more accurate distance image, for example, because of pixel characteristics improved by the application of the foregoing photoelectric conversion apparatus.

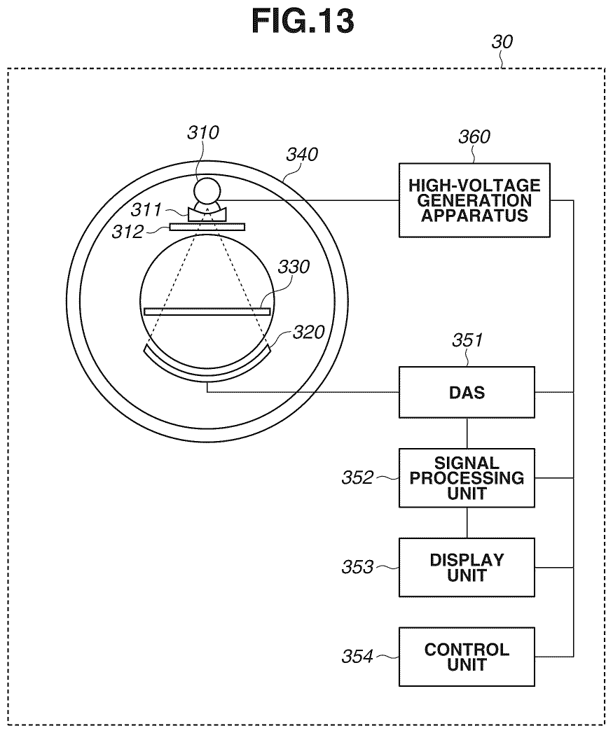

FIG. 13 is a block diagram of an X-ray computed tomography (CT) device according to a seventh exemplary embodiment. The photoelectric conversion apparatuses described in the first to third exemplary embodiments can be applied to the detector of the X-ray CT device. An X-ray CT device 30 according to the present exemplary embodiment includes an X-ray generation unit 310, a wedge 311, a collimator 312, an X-ray detection unit 320, a top plate 330, a rotating frame 340, and a high-voltage generation apparatus 360. The X-ray CT device 30 further include a data acquisition system (DAS) 351, a signal processing unit 352, a display unit 353, and a control unit 354.

The X-ray generation unit 310 includes a vacuum tube that generates X-rays, for example. A high voltage and a filament current from the high-voltage generation apparatus 360 are supplied to the vacuum tube of the X-ray generation unit 310. The anode (target) is irradiated with thermal electrons from the cathode (filament), whereby X-rays are generated.

The wedge 311 is a filter for adjusting the amount of X-rays emitted from the X-ray generation unit 310. The wedge 311 attenuates the amount of X-rays so that the X-rays emitted from the X-ray generation unit 310 to the subject have a predetermined distribution. The collimator 312 includes lead plates for narrowing the irradiation range of the X-rays transmitted through the wedge 311. The X-rays generated by the X-ray generation unit 310 are shaped into a cone beam through the collimator 312, and the subject on the top plate 330 is irradiated with the cone beam.

The X-ray detection unit 320 includes the photoelectric conversion apparatus described in one of the foregoing first to third exemplary embodiments. The X-ray detection unit 320 detects the X-rays from the X-ray generation unit 310 that have passed through the subject, and outputs a signal corresponding to the amount of X-rays to the DAS 351.

The rotating frame 340 has an annular shape and is configured to be rotatable. The X-ray generation unit 310 (wedge 311, collimator 312) and the X-ray detection unit 320 are opposed to each other inside the rotating frame 340. The X-ray generation unit 310 and the X-ray detection unit 320 can rotate with the rotating frame 340.

The high-voltage generation apparatus 360 includes a boosting circuit, and outputs a high voltage to the X-ray generation unit 310. The DAS 351 includes an amplification circuit and an analog-to-digital (A/D) conversion circuit. The DAS 351 outputs the signal from the X-ray detection unit 320 to the signal processing unit 352 as digital data.

The signal processing unit 352 includes a central processing unit (CPU), a read-only memory (ROM), and a random access memory (RAM), and can perform image processing on the digital data. The display unit 353 includes a flat display device and can display an X-ray image. The control unit 354 includes a CPU, a ROM, and a RAM, and controls the operation of the entire X-ray CT device 30.

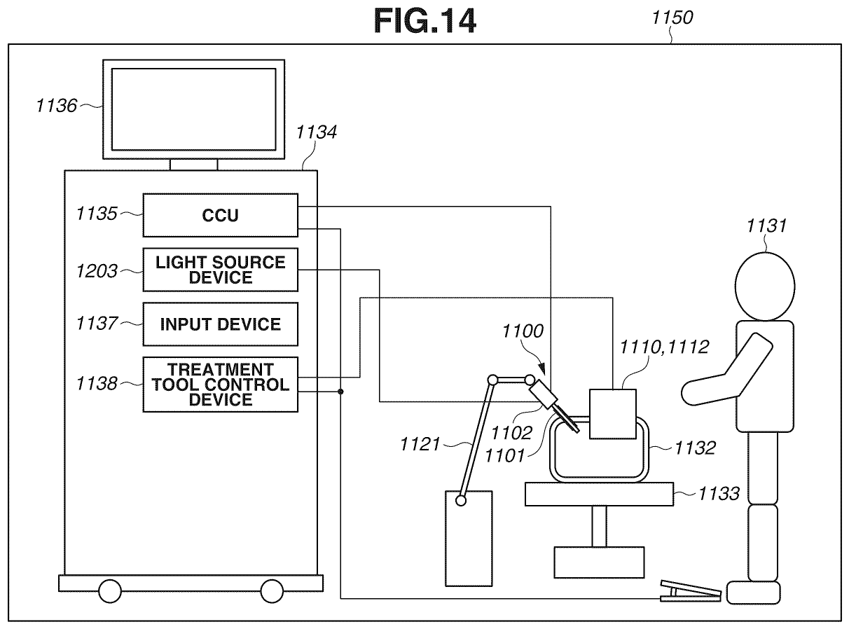

A photoelectric conversion system according to an eighth exemplary embodiment will be described with reference to FIG. 14. FIG. 14 is a diagram illustrating an example of a schematic configuration of an endoscopic surgery system that is the photoelectric conversion system according to the present exemplary embodiment.

FIG. 14 illustrates a state where a surgeon (doctor) 1131 is performing surgery on a patient 1132 lying on a patient bed 1133 using an endoscopic surgery system 1150. As illustrated in FIG. 14, the endoscopic surgery system 1150 includes an endoscope 1100, a surgical tool 1110, and a cart 1134 on which various devices for endoscopic surgery are mounted.

The endoscope 1100 includes a lens barrel 1101, a predetermined length of which from the tip is inserted into a body cavity of the patient 1132, and a camera head 1102 that is connected to the bottom of the lens barrel 1101. In the illustrated example, the endoscope 1100 is configured as a rigid scope with a rigid lens barrel 1101. However, the endoscope 1100 may be configured as a flexible scope with a flexible lens barrel.

The tip of the lens barrel 1101 has an opening with an objective lens fitted thereto. A light source device 1203 is connected to the endoscope 1100. Light generated by the light source device 1203 is guided to the tip of the lens barrel 1101 by a lightguide extended through the lens barrel 1101, and emitted toward an observation target in the body cavity of the patient 1132 through the objective lens. The endoscope 1100 may be a forward-viewing endoscope, an oblique-viewing endoscope, or a side-viewing endoscope.

An optical system and a photoelectric conversion apparatus are disposed inside the camera head 1102. Reflected light (observation light) from the observation target is collected to the photoelectric conversion apparatus through the optical system. The photoelectric conversion apparatus photoelectrically converts the observation light to generate an electrical signal corresponding to the observation light, or equivalently, an image signal corresponding to an observation image. The photoelectric conversion apparatuses (imaging apparatuses) described in the foregoing exemplary embodiments can be used as the photoelectric conversion apparatus. The image signal is transmitted to a camera control unit (CCU) 1135 as raw data.

The CCU 1135 includes a CPU and a graphics processing unit (GPU), and controls the operation of the endoscope 1100 and a display device 1136 in a centralized manner. The CCU 1135 receives the image signal from the camera head 1102, and applies various types of image processing for displaying an image based on the image signal, such as development processing (demosaicing processing), to the image signal.

The display device 1136 displays an image based on the image signal to which the image processing is applied by the CCU 1135, under control of the CCU 1135.

The light source device 1203 includes a light source such as a light-emitting diode (LED), for example, and supplies irradiation light to the endoscope 1100 in capturing an image of a surgical site.

An input device 1137 is an input I/F for the endoscopic surgery system 1150. The user can input various types of information and instructions to the endoscopic surgery system 1150 via the input device 1137.

A treatment tool control device 1138 controls driving of an energy treatment tool 1112 for tissue cauterization, cutting, or sealing of blood vessels.

The light source device 1203 that supplies the endoscope 1100 with the irradiation light in capturing an image of the surgical site can include an LED, a laser light source, or a white light source constituted by a combination of these, for example. If the white light source is constituted by a combination of red, blue, and green (RGB) laser light sources, the light source device 1203 can adjust the white balance of the captured image since the output intensity and output timing of each color (wavelength) can be controlled with high precision. In such a case, images corresponding to the respective colors R, G, and B can be captured in a time-division manner by irradiating the observation target with the respective laser beams from the RGB laser light sources in a time-division manner and controlling the driving of the image sensor of the camera head 1102 in synchronization with the irradiation timing. According to such a method, a color image can be obtained without providing color filters on the image sensor.

The driving of the light source device 1203 can be controlled so that the intensity of the output light changes at predetermined time intervals. A high dynamic range image with no underexposure or overexposure can be generated by controlling the driving of the image sensor of the camera head 1102 in synchronization with the changing timing of the light intensity to obtain images in a time-division manner and combining the images.

The light source device 1203 may be configured so that light in a predetermined wavelength band for special light observation can be supplied. Special light observation uses the wavelength dependence of light absorption by body tissues, for example. Specifically, a high-contrast image of predetermined tissues such as blood vessels in the mucosal surface layer is captured by irradiating the mucosal surface layer with narrow-band light compared to the irradiation light used during normal observation (i.e., white light).

As another example of special light observation, fluorescence observation may be performed to obtain images based on fluorescence caused by excitation light irradiation. In fluorescence observation, fluorescence images can be obtained by irradiating body tissues with excitation light and observing fluorescence from the body tissues, or by locally injecting a reagent, such as indocyanine green (ICG), into body tissues and irradiating the body tissues with excitation light corresponding to the fluorescence wavelength of the reagent. The light source device 1203 can be configured to be capable of supplying narrow-band light and/or excitation light for such special light observation.

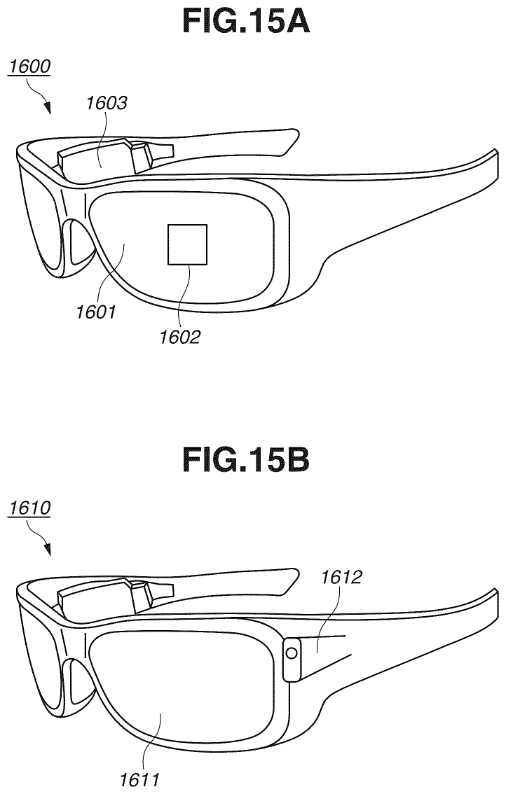

A photoelectric conversion system according to a ninth exemplary embodiment will be described with reference to FIGS. 15A and 15B. FIG. 15A illustrates glasses 1600 (smart glasses) that are the photoelectric conversion system according to the present exemplary embodiment. The glasses 1600 include a photoelectric conversion apparatus 1602. The photoelectric conversion apparatus 1602 is the photoelectric conversion apparatus (imaging apparatus) according to one of the foregoing exemplary embodiments. A display device including a light emitting device such as an organic light-emitting diode (OLED) and an LED may be disposed on the back side of a lens 1601. The number of photoelectric conversion apparatuses 1602 may be one or more. A plurality of types of photoelectric conversion apparatuses may be used in combination. The layout position of the photoelectric conversion apparatus 1602 is not limited to that in FIG. 15A.

The glasses 1600 further include a control apparatus 1603. The control apparatus 1603 functions as a power supply for supplying power to the photoelectric conversion apparatus 1602 and the display device. The control apparatus 1603 controls operation of the photoelectric conversion apparatus 1602 and the display device. The lens 1601 includes an optical system for collecting light to the photoelectric conversion apparatus 1602.

FIG. 15B illustrates glasses 1610 (smart glasses) according to an application example. The glasses 1610 include a control apparatus 1612. The control apparatus 1612 includes a photoelectric conversion apparatus equivalent to the photoelectric conversion apparatus 1602, and a display device. The photoelectric conversion apparatus in the control apparatus 1612 and an optical system for projecting light emitted from the display device are formed on a lens 1611, and an image is projected on the lens 1611. The control apparatus 1612 functions as a power supply for supplying power to the photoelectric conversion apparatus and the display device, and controls operation of the photoelectric conversion apparatus and the display device. The control apparatus 1612 may include a line of sight detection unit that detects the wearer's line of sight. The line of sight may be detected using infrared rays. An infrared light emission unit emits infrared rays to an eyeball of the user gazing at a displayed image. An imaging unit including a light receiving element detects reflection of the emitted infrared rays from the eyeball, whereby a captured image of the eyeball is obtained. The glasses 1610 include a reduction unit configured to reduce light traveling from the infrared light emission unit to the display unit in a plan view, whereby a drop in image quality is reduced.

The user's line of sight to the displayed image is detected from the captured image of the eyeball obtained by the infrared imaging. Any conventional technique can be applied to the line of sight detection using the captured image of the eyeball. For example, a line of sight detection method based on a Purkinje image formed by the reflection of the irradiation light on the cornea can be used.

More specifically, line of sight detection processing based on the pupil-cornea reflection method is performed. The user's line of sight is detected by calculating a line of sight vector indicating the direction (rotation angle) of the eyeball based on the pupil image and the Purkinje image included in the captured image of the eyeball, using the pupil-cornea reflection method.

The display device according to the present exemplary embodiment may include a photoelectric conversion apparatus including a light receiving element, and control the displayed image on the display device based on the user's line of sight information from the photoelectric conversion apparatus.

Specifically, the display device determines a first field of view region that the user is gazing at and a second field of view region other than the first field of view region, based on the line of sight information. The first field of view region and the second field of view region may be determined by a control apparatus of the display device. First and second field of view regions determined by an external control apparatus may be received. The display resolution of the first field of view region on the display region of the display device may be controlled to be higher than that of the second field of view region. In other words, the second field of view region may have a resolution lower than that of the first field of view region.

The display region may include a first display region and a second display region different from the first display region, and a region of higher priority may be determined between the first and second display regions based on the line of sight information. The first and second display regions may be determined by the control apparatus of the display device. First and second display regions determined by an external control apparatus may be received. The resolution of the region of higher priority may be controlled to be higher than that of the region other than the region of higher priority. In other words, the region of relatively low priority may have a lower resolution.

The first field of view region or the region of higher priority may be determined using artificial intelligence (AI). The AI may be a model that is configured to estimate the angle of the line of sight and the distance to an object in front of the line of sight from the eyeball image, with eyeball images and the actual viewing directions of the eyeballs in the images as training data. Such an AI program may be included in the display device, the photoelectric conversion apparatus, or an external apparatus. If the external apparatus includes the AI program, the estimation results are transmitted to the display device through communication.

If display control is performed based on visual detection, smart glasses further including a photoelectric conversion apparatus for capturing an image of the exterior can be suitably applied. The smart glasses can display the captured external information in real time.

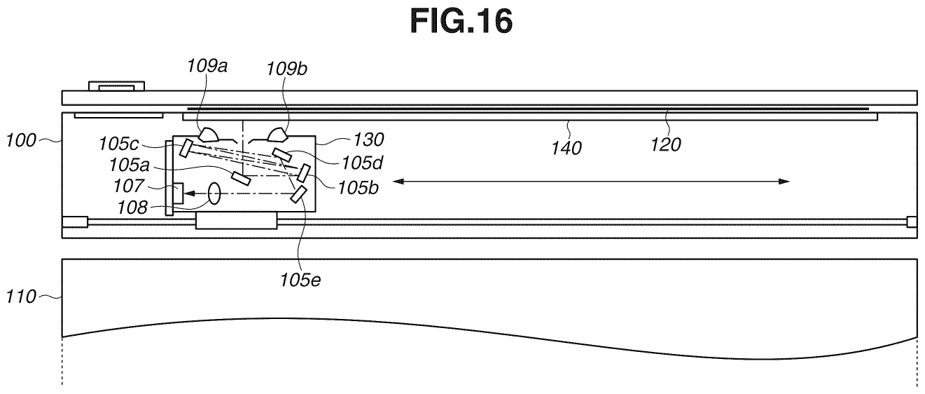

FIG. 16 is a sectional view illustrating an internal configuration of a document reading apparatus that is an image reading apparatus according to a tenth exemplary embodiment. A conventional image forming unit 110 is located under the document reading apparatus 100. The document reading apparatus 100 and the image forming unit 110 constitute an image forming apparatus. An example of the conventional image forming unit 110 is an electrophotographic image forming unit. The electrophotographic image forming unit forms an image by developing an electrostatic latent image formed on a photoelectric drum into a toner image and transferring the toner image to a recording medium such as paper. The image forming apparatus according to the tenth exemplary embodiment can form an image read by the document reading apparatus 100 on a recording medium using the image forming unit 110.

A sheet (hereinafter, document) 120 on which an image to be read is formed is placed on a document positioning glass 140. When the user presses a read start button (not illustrated), a reading unit 130 moves in the direction of the arrow in the diagram and reads the document 120.

When moving in the direction of the arrow, the reading unit 130 turns on white LEDs 109a and 109b serving as light emitting units, located in the upper part of the reading unit 130, to irradiate the document 120 with light.

The reading unit 130 is a reduction optical system reading unit including the LEDs 109a and 109b, a plurality of folding mirrors 105a, 105b, 105c, 105d, and 105e, a condenser lens 108, and a photoelectric conversion apparatus 107. The light emitted toward the document 120 from the LEDs 109a and 109b is reflected by the document 120. The light reflected from the document 120 is reflected by the folding mirrors 105a, 105b, 105c, 105d, and 105e, and then collected to the photoelectric conversion apparatus 107 that is a line sensor through the condenser lens 108. The photoelectric conversion apparatus 107 includes light receiving elements. The light receiving elements photoelectrically convert the incident light and output electrical signals corresponding to the amount of incident light.

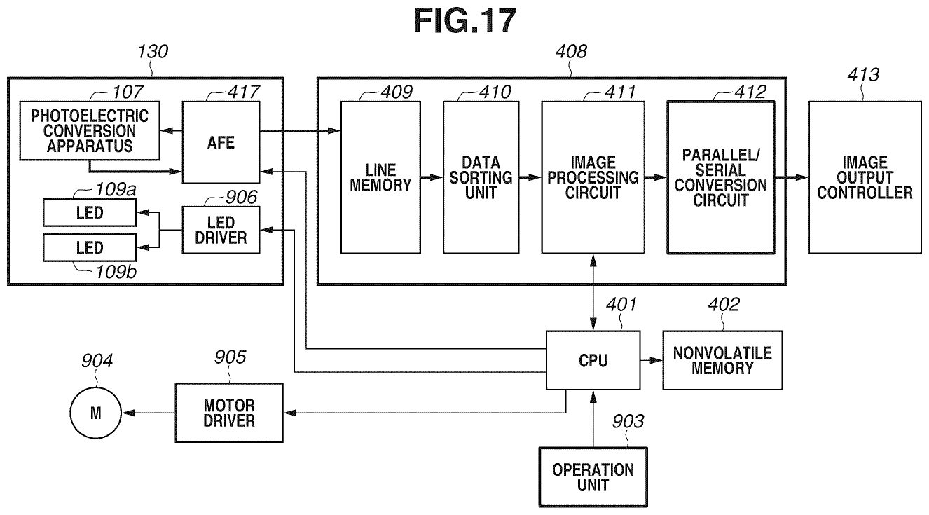

FIG. 17 is a block diagram of the document reading apparatus 100 according to the present exemplary embodiment.

A CPU 401 reads a control program stored in a nonvolatile memory 402 and controls the entire document reading apparatus 100. An operation unit 903 is a user I/F for the user to input copy mode settings such as color copy, monochrome copy, and two-sided copy, and an instruction to start copy. A motor 904 moves the reading unit 130 in a sub scanning direction. A motor driver 905 receives a timing signal from the CPU 401 and supplies an excitation current for controlling rotation of the motor 904.

An LED driver 906 receives a timing signal from the CPU 401 and supplies a current for causing the white LEDs 109a and 109b to emit light.

An integrated circuit (IC) 417 performs analog processing such as sample-and-hold processing, offset processing, and gain processing on an analog voltage signal output from the photoelectric conversion apparatus 107, and converts the analog-processed voltage signal into digital data (hereinafter, luminance data). The IC 417 is typically referred to as an analog front end (AFE). In the present exemplary embodiment, this digital data is eight-bit data (0 to 255).

The operation of the image processing unit 408 will be described. Reading data output from the AFE 417 is stored in a line memory 409. The line memory 409 stores reading data read in respective light receiving element rows line 1, line 2, and line 3 in the photoelectric conversion apparatus 107.

A data sorting unit 410 sorts the pieces of reading data obtained from lines 1, 2, and 3 to generate image data in each of RGB colors. R processing will be described as an example. The data sorting unit 410 extracts R data portions from the pieces of image data of lines 1, 2, and 3 stored in the line memory 409. Since the pieces of reading data of lines 1, 2, and 3 acquired at a certain timing are offset in the sub scanning direction, the data sorting unit 410 performs processing for eliminating the offsets. Specifically, the data sorting unit 410 processes the pieces of data acquired at a certain timing so that the reading data of line 2 shifts by two pixels in the sub scanning direction, and the reading data of line 3 by four pixels in the sub scanning direction. The offsets in the sub scanning direction are eliminated by such processing. This processing is performed on each color, whereby the reading data read by the photoelectric conversion apparatus 107 becomes free of offsets in the sub scanning direction, resulting in reading data corresponding to the image of the document 120.

An image processing circuit 411 performs image processing such as shading correction processing and filter processing on the reading data sorted by the data sorting unit 410. The filter settings for performing the image processing are set into a register inside the image processing circuit 411 by the CPU 401 upon power-on.

A parallel/serial conversion circuit 412 converts the reading data that is given the various types of image processing and output from the image processing circuit 411 as parallel data into serial data. The converted serial reading data is transmitted to an image output controller 413.

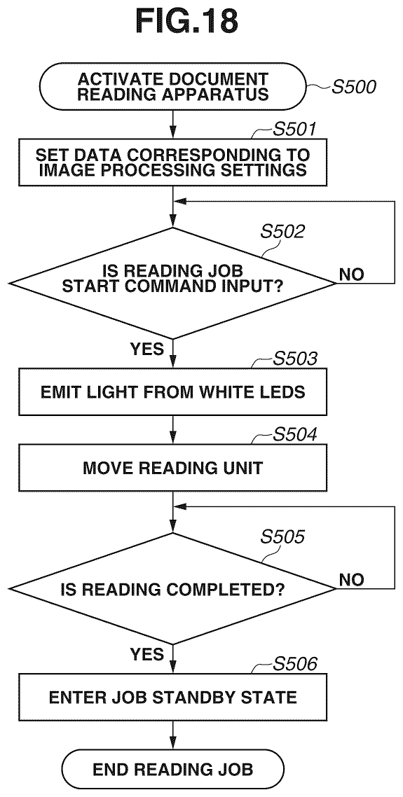

FIG. 18 is a control flowchart for the CPU 401 according to the present exemplary embodiment.

In step S500, the user powers the document reading apparatus 100 on, and the CPU 401 performs initial operations such as launching processing of a document reading apparatus control program and adjustment of the amount of light of the LEDs 109a and 109b (activation of the document reading apparatus 100).

In step S501, the CPU 401 sets data corresponding to image processing settings into the register inside the image processing circuit 411.

In step S502, the CPU 401 waits for a reading job start command from the operation unit 903.

If the user inputs the reading job start command (YES in step S502), the processing proceeds to step S503. In step S503, the CPU 401 causes the white LEDs 109a and 109b that are the light sources to emit light. The CPU 401 outputs a control signal to the LED driver 906, and the LED driver 906 supplies a current to the LEDs 109a and 109b for light emission.

In step S504, the CPU 401 outputs a control signal to the motor driver 905, and the motor driver 905 drives the motor 904 to move the reading unit 130 in the sub scanning direction.

If the reading is completed (YES in step S505), the processing proceeds to step S506. In step S506, the CPU 401 turns the LEDs 109a and 109b off, and controls the document reading apparatus 100 to enter a job standby state.

In this specification, expressions such as “A or B”, “at least one of A and B”, “at least one of A and/or B”, and “one or more of A and/or B” may be used. Such expressions can include all possible combinations of the cited items unless otherwise explicitly defined. In other words, the foregoing expressions are understood to discuss all cases where at least A is included, where at least B is included, and where at least A and at least B are both included. The same applies to combinations of three or more elements.

The disclosure of this specification includes the complementary of the set of concepts described in this specification as well. In other words, if, for example, this specification states “A is B” (A=B), it is to be understood that this specification discusses or implies “A is not B” (A≠B) even if the statement “A is not B” is omitted. The reason is that when stating “A is B”, it is presumed that the case where “A is not B” has been considered.

The exemplary embodiments described above can be modified as appropriate without departing from the technical concept. The disclosure of this specification includes not only what is described in this specification but all matters comprehensible from this specification and the drawings attached to this specification. The disclosure of this specification includes the complementary of the set of concepts described in this specification as well. In other words, if, for example, this specification states “A is greater than B”, it can be said that this specification discusses “A is not greater than B” even if the statement “A is not greater than B” is omitted. The reason is that when stating “A is greater than B”, it is presumed that the case where “A is not greater than B” has been considered.

In a photoelectric conversion apparatus having a mode where a plurality of different signal scans is simultaneously performed in parallel, crosstalk can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-202723, filed Nov. 30, 2023, which is hereby incorporated by reference herein in its entirety.

What is claimed is:

1. An apparatus comprising:
a plurality of pixels arranged in a plurality of rows and a plurality of columns; and
a plurality of signal lines,
wherein each of the plurality of pixels includes a photoelectric conversion unit and a selection unit configured to control output of a pixel signal based on a charge generated by the photoelectric conversion unit to the signal lines,
wherein the plurality of pixels includes a first pixel located at a first column and a first row, a second pixel located at the first column and a second row, and a third pixel located at a second column and the second row, the second column adjoining the first column,
wherein the plurality of signal lines includes a first group including one or more of the signal lines and including a first signal line connected to the first pixel, a second group including one or more of the signal lines and including a second signal line connected to the second pixel, and a third group including one or more of the signal lines and including a third signal line connected to the third pixel,
wherein the apparatus further comprises first connection wiring connected to the selection unit of the first pixel and the first signal line,
wherein first shield wiring to which a fixed potential is supplied is located between the first group and the second group including the third signal line, and
wherein the first connection wiring overlaps the first group and not the second group including the second signal line in a plan view in a direction orthogonal to a surface where the plurality of pixels is arranged.

2. The apparatus according to claim 1, further comprising second connection wiring connected to the selection unit of the second pixel and the second signal line,
wherein the second connection wiring overlaps the second group including the second signal line and not the first group in the plan view.

3. The apparatus according to claim 2,
wherein the first connection wiring and the second connection wiring are disposed on a layer between wiring layer where the plurality of signal lines is disposed and a semiconductor layer where the photoelectric conversion unit is disposed, and
wherein the layer where the first connection wiring and the second connection wiring are disposed is a wiring layer adjoining the wiring layer where the plurality of signal lines is disposed.

4. The apparatus according to claim 3, wherein a number of signal lines included in the first group is greater than a number of signal lines included in the second group including the second signal line.

5. The apparatus according to claim 4,
wherein the first group and the second group include a portion disposed on a first layer, and
wherein second shield wiring to which a fixed potential is supplied is disposed on the first layer between the first group and the second group including the second signal line, the second shield wiring extending in parallel with the signal lines.

6. The apparatus according to claim 5,
wherein third connection wiring connected to the selection unit of the third pixel and the third signal line is disposed on the same layer as is the first connection wiring, and
wherein third shield wiring to which a fixed potential is supplied is located between the second connection wiring and the third connection wiring.

7. The apparatus according to claim 6, wherein the second shield wiring and the third shield wiring overlap, at least in part, in the plan view.

8. The apparatus according to claim 6, wherein fourth shield wiring to which a fixed potential is supplied is located between the second connection wiring and the third connection wiring.

9. The apparatus according to claim 8, wherein the first shield wiring and the fourth shield wiring overlap, at least in part, in the plan view.

10. The apparatus according to claim 1, wherein in a predetermined mode, the signal line(s) constituting the first group is/are used to read an image signal for moving image display, and the signal line(s) constituting the second group including the second signal line is/are used to read an image signal for sensing.

11. The apparatus according to claim 10,
wherein the plurality of pixels includes a fourth pixel located at the first column and a third row,
wherein the plurality of signal lines includes a third group including one or more of the signal lines and including a fourth signal line connected to the fourth pixel, and
wherein in the predetermined mode, the signal line(s) constituting the third group is/are not used to read an image signal for moving image display or an image signal for sensing.

12. The apparatus according to claim 11, wherein in the predetermined mode, a fixed potential is applied to the third group.

13. The apparatus according to claim 12, wherein the signal line(s) constituting the third group is/are located between the first group and the second group including the second signal line.

14. The apparatus according to claim 1, wherein a source region of a transistor constituting the selection unit is located between the first group and the second group including the second signal line in the plan view.

15. The apparatus according to claim 1,
wherein the photoelectric conversion unit is disposed on a semiconductor layer, and
wherein the apparatus is irradiated with light from a side opposite from where the signal lines and the first connection wiring are disposed.

16. The apparatus according to claim 1,
wherein the plurality of pixels is disposed on a first semiconductor layer,
wherein a scanning circuit configured to control driving of the plurality of pixels is disposed on a second semiconductor layer, and
wherein the first and second semiconductor layers are stacked.

17. A system comprising:
the apparatus according to claim 1; and
a processing unit configured to generate an image using a signal output from the apparatus.

18. The system according to claim 17, further comprising second connection wiring connected to the selection unit of the second pixel and the second signal line,
wherein the second connection wiring overlaps the second group including the second signal line and not the first group in the plan view.

19. A moving body comprising:
the apparatus according to claim 1; and
a control unit configured to control movement of the moving body using a signal output from the apparatus.

20. The moving body according to claim 19, further comprising second connection wiring connected to the selection unit of the second pixel and the second signal line,
wherein the second connection wiring overlaps the second group including the second signal line and not the first group in the plan view.
